(19) United States
(12) Patent Application Publication
(10) Pub. No.: US 2018/0018721 A1
(43) Pub. Date: Jan. 18, 2018

(54) CUSTOMER TYPE DETECTION AND CUSTOMIZATION FOR ONLINE SERVICES

(71) Applicant: MICROSOFT TECHNOLOGY LICENSING, LLC, Redmond, WA (US)

(72) Inventors: Zohaib Ali, Redmond, WA (US); Srinivasa Reddy Manda, Redmond, WA (US); Tao Zhang, Redmond, WA (US); Sirish Balaga, Redmond, WA (US); Christian Piccolo, Redmond, WA (US); Nadeem Ansari, Redmond, WA (US); Gerard Reese, Auburn, WA (US)

(73) Assignee: MICROSOFT TECHNOLOGY LICENSING, LLC, Redmond, WA (US)

(21) Appl. No.: 15/366,651

(22) Filed: Dec. 1, 2016

Related U.S. Application Data
(60) Provisional application No. 62/361,457, filed on Jul. 12, 2016.

(51) Int. Cl. G06Q 30/06; G06N 5/04; G06F 17/30

(52) U.S. Cl. CPC G06Q 30/0601; G06F 17/30864; G06N 5/04

(57) ABSTRACT

Customer type detection and customization and/or configuration of services based on detected customer type is provided in an online service environment. In some examples, a small business customer signing up for an email account or similar (e.g., more complex services such as a productivity suite) way be detected as a small business based on a choice of their email alias, domain name, signature, and other factors. A type of business may also be detected/inferred. Based on the detection inference, the services such as initial teaching user experiences, configuration of services, and other customizations may be automatically provided or suggested to the customer. Subsequently, usage may be monitored and further services and/or configurations (configuration changes) may be suggested based on additionally gathered information and changes in usage.

### CROSS-REFERENCE TO RELATED APPLICATION

This Application claims priority under 35 U.S.C. §119(e) to U.S. Provisional Patent Application Ser. No. 62/361,457 filed on Jul. 12, 2016. The disclosure of the U.S. Provisional Patent Application is hereby incorporated by reference in its entirety.

### BACKGROUND

Online services increasingly provide useful tools for a variety of customers ranging from large enterprise entities, to small businesses, to individuals. With the increasing variety and depth of the provided services, setting up those services, initial configuration, and ongoing adjustments may be difficult for some customers. Enterprise entities typically have dedicated professionals, but individuals or small businesses may lack the resources and knowledge to set up the services and make configuration decisions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to customer type detection and customization and/or configuration of available services. In some examples, a sign-up request for one or more services may be received by a sign-up module or configuration module of a hosted service. One or more signals provided by a customer requesting the sign-up such as an email alias, a domain name, a signature, one or more contacts, a template selection, and/or a service selection may be analyzed. An inference on the customer type may be made based on results oldie analysis. The available services and their components may then be customized and configured according to the inference.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 includes a display diagram of an example network environment where a system to provide customer type detection and customization and/or configuration of available services may be implemented;

FIG. 2 includes a display diagram illustrating major blocks in customer type detection and customization and/or configuration of services based on detected customer type in an online service environment;

FIG. 3 includes a display diagram conceptually illustrating some initial data capture to be used in customer type detection and customization and/or configuration of services based on detected customer type in an online service environment;

FIG. 4 is a display diagram illustrating an optionally looped flow of analysis, inference, and customization/configuration in providing customers hosted services;

FIG. 5 is a networked environment, where a system according to embodiments may be implemented;

FIG. 6 is a block diagram of an example general purpose computing device, which may be used to provide customer type detection and customization and/or configuration of services; and

FIG. 7 illustrates a logic flow diagram of a method to provide customer type detection and customization and/or configuration of services, arranged in accordance with at least some embodiments.

### DETAILED DESCRIPTION

As briefly described above, embodiments are directed to customer type detection and customization and/or configuration of services based on detected customer type in an online service environment. In some examples, a small business customer signing up for an email account or similar (e.g., more complex services such as a productivity suite) may be detected as a small business based on a choice of their email alias, domain name, signature, and other factors. A type of business may also be detected/inferred. Based on the detection/inference, the services such as initial teaching user experiences, configuration of services, and other customizations may be automatically provided or suggested to the customer. Subsequently, usage may be monitored and further services and/or configurations (configuration changes) may be suggested based on additionally gathered information and changes in usage.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including band-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es), The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing c customer type detection and customization and/or configuration of services based on detected customer type in an online service environment. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

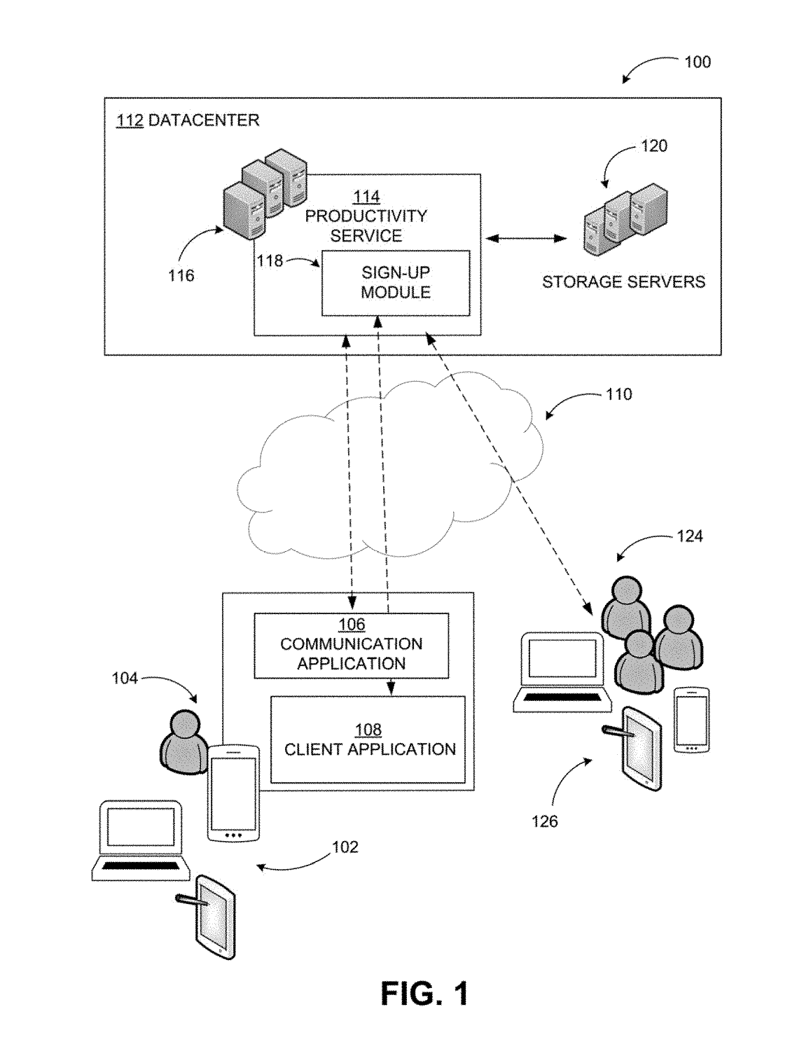

FIG. 1 includes air example network environment where a system to provide customer type detection and customization and/or configuration of services based on detected customer type may be implemented.

As illustrated in diagram 100, an example system may include a datacenter 112 hosting a cloud-based productivity service 114 configured to provide communication, document processing, presentation, calendar management, and comparable services that may be accessed across multiple devices and users. The datacenter 112 may include one or more processing servers 116 configured to execute the productivity service 114, among other components. In some embodiments, at least one of the processing servers 116 may be operable to manage the productivity service 114, where data from devices (such as devices 102 and 126) may be stored at storage servers 120 (or associated data stores). The productivity service 114 may include, among other modules and applications, a sign-up module or application 118, Which may be configured to receive sign-up requests and process them to allow new customers to sign up for the productivity service 114 or existing customers to change their subscription or service level. As described herein, the productivity service 114 may be implemented as software, hardware, or combinations thereof.

In some embodiments, the productivity service 114 may be configured to intemperate with various applications to provide its services. For example, as illustrated in the diagram 100, a user 104 may execute a thin (e.g., a web browser) or a thick (e.g., a locally installed client application) version of a communication application 106 through the device 102 with which the productivity service 114 may be configured to integrate and interoperate with over one or more networks, such as network 110. Similarly, client application 108 may be an application to provide access to one or more components of the productivity service 114 at the device 102. The communication application 106 and the client application 108 may be applications hosted by the productivity service, such as clients, for example. The device 102 may include a desktop computer, a laptop computer, a tablet computer, a vehicle mount computer, a smart phone, or a wearable computing device, among other similar devices. A communication interface may facilitate communication between the productivity service 114 and the communication application 106 or client application 108 over the network 110.

In an example scenario, the sign-up module or application 118 of the productivity service 114 may receive a request from a small business customer to sign up for an email account or similar (e.g., more complex services such as a productivity suite). The sign-up module may analyze signals from the customer such as their choice of email alias, domain name, signature, and other factors. A type of business may then be inferred. Based on the detection/inference, the services such as initial teaching user experiences, configuration of services, and other customizations may be automatically provided or suggested to the customer.

The technical advantages of providing customer type detection and customization and/or configuration of services based on detected customer type in an online service environment may include, among others, increased security and efficiency in user interaction and data management, reduced processing and network bandwidth usage, and improved user interaction by allowing users to receive services and configurations without having to handle those manually and at individual steps.

Embodiments, as described herein, address a need that arises from very large scale of operations created by software-based services that cannot be managed by humans. The actions; operations described herein are not a mere use of a computer, but address results of a system that is a direct consequence of software used as a service offered in conjunction with large numbers of users signing up to online services and having customization/configuration needs.

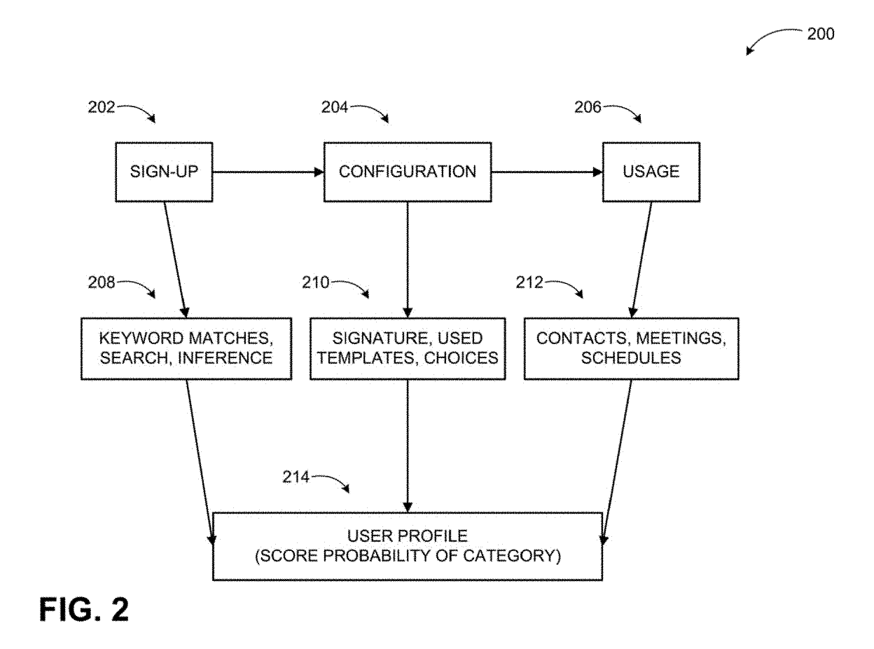

FIG. 2 includes a display diagram illustrating major blocks in customer type detection and customization and/or configuration of services based on detected customer type in an online service environment.

As discussed previously, a customer's type such as a small business, an individual, or similar, may be detected/inferred based on a number of factors at sign-up time 202 for the service. For example, the service may include a productivity service with an email component and the customer may be signing up for a new email account. The system may analyze the customer's requested email alias, domain name (requested or already registered), a signature, selected templates, etc. to infer the customer type. For example, if the customer requests an email alias Johnsmassageparlor, the inference may be that the customer is a small business in the massage parlor business. In other examples, a domain name (already registered to the customer or being requested) may provide similar input for inference. In yet other examples, the customer may select a first name and a last name for email alias. The system may perform a search identifying the customer and inferring the customer type from the results of the search 208. In further examples, a signature designed by the customer, a background selected or designed by the customer, and similar information may be used for the inference 210. The inference may be score-based. That is a confidence score (e.g., low, medium, high, or numeric) may be assigned to the inferred customer type based on the information used for the inference.

In some embodiments, the inference from multiple sources of information (208, 210, 212) may be used to create customer profile 214. The inference and/or the customer profile may be used to provide initial selection/configuration 204 of services. For example, initial teaching user experiences, providing the customer information associated with the available services and their use may be tailored based on the customer profile. Aspects of services such as user interfaces, available features, and similar ones (e.g., application components within the productivity suite) may be selected or configured based on the profile/inference too.

Some of the information that, if available, may be used for inference. If such information is not available, it may also be used as suggestion to the customer as a result of the inference. For example, if the customer does not provide a signature, but the customer type (and business type) are inferred from other information sources, a template signature (210) fitting the customer type may be suggested.

In yet other examples, customer usage 206 such as number and type of contacts (212), used document types, selected templates, etc. may be monitored after the initial configuration and adjustments to the selection of available services, configurations made based on the additional information. The inference/profile may be used to automatically make configurations or selections. In other examples, the configurations selections may be provided to the customer as suggestions based on the inference/profile.

While a productivity service is used as an illustrative example herein, embodiments may be implemented in other service environments as well. For example, communication services, networking services, collaboration services, combined productivity and collaboration services, or other comparable services may be used to implement customer type detection and customization and/or configuration of services based on detected customer type.

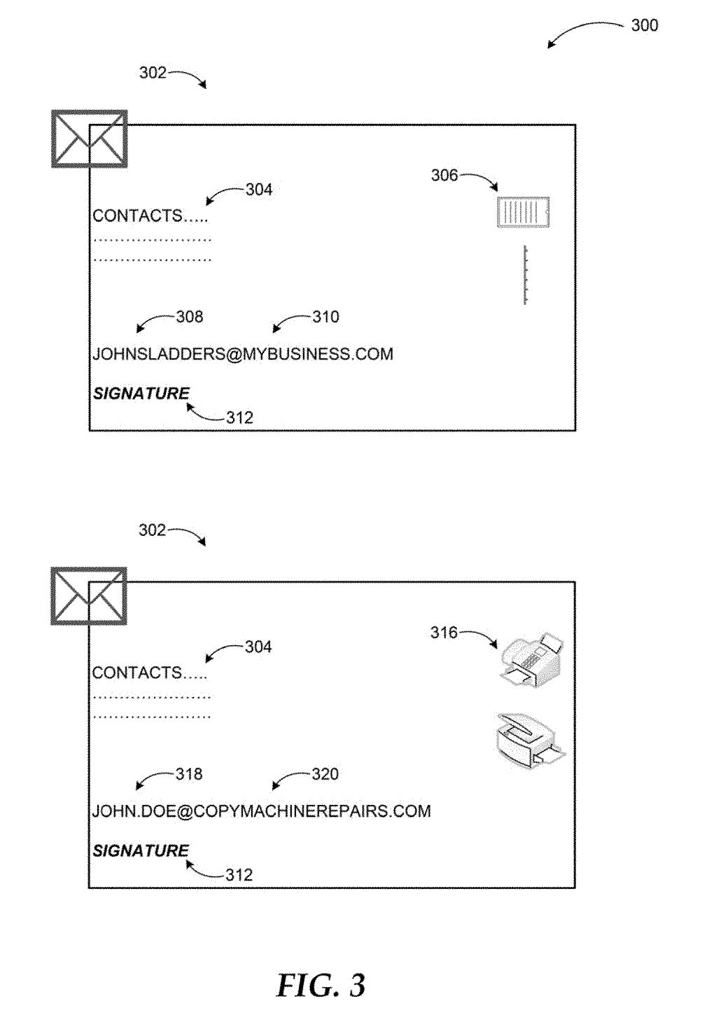

FIG. 3 includes a display diagram conceptually illustrating some initial data capture to be used in customer type detection and customization and/or configuration of services based on detected customer type in an online service environment.

As shown in diagram 300, various pieces of information provided by the customer during initial sign-up may be used to make inferences about the customer type and configure/provide services based on the inferences. The examples may include, but are not sited to, email alias 308 domain name 310, contacts 304, selected background templates 306, signature 312, etc. as shown in example email template 302 As discussed above, in other examples, some of the information, which may be used to make the inference may not be provided by the customer and instead suggested to the customer as a result of the inference.

Example email template 320 shows yet another scenario with email alias 326, domain name 328, contacts 322, selected background templates 324, signature 330. Based on the example signals, the customer type and their specific business may be inferred with a high confidence and the requested service components configured or customized accordingly.

In some embodiments, the sources of information (also referred to as “signals”) may be assigned weights based on how strongly they can influence the inference or provide reliable information. For example, an email alias that includes a description of the business (e.g., carrental) may be a strong indicator, while a name of the customer may be a weaker indicator. Thus, the weights may be assigned to the different signals based on how strong indicators they provide in computing a confidence score for the inference.

The signals shown in diagram 300 for inferring customer type may also be used as custom templates to be provided to a customer upon confirmation of the inference, For example, signature, contacts, background templates, etc. may be suggested upon conclusion.

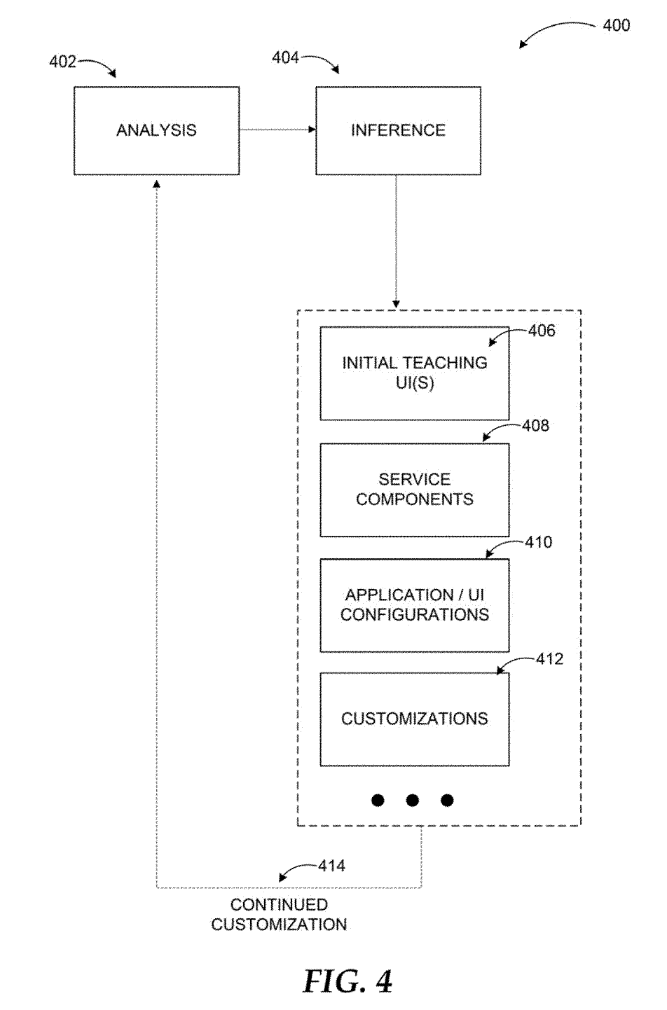

FIG. 4 is a display diagram illustrating an optionally looped flow of analysis, inference, and customization/configuration in providing customers hosted services.

As discussed above, various signals from a signing up customer for an online service may be analyzed (402) and an inference 404 made as to a customer type and/or a specific customer business/organization. Based on the inference, customization ardor configuration of service features such as initial teaching user interfaces 406, available components 408, application configurations and/or user interfaces 410, training tutorials, and other customizations 412 may be determined for the signing up customer.

After the initial set up, the customer's usage may be monitored for changes in suggested customizations/configurations, customer behavior, etc. The analysis 402 may be repeated at regular intervals or upon detection of a threshold of changes. The inference 404 may change based on the repeat analysis resulting in automatic (and/or suggested) changes to the configurations and customizations.

The examples provided in FIG. 1 through 4 are illustrated with specific systems, services, applications, modules, codes, and notifications. Embodiments are not limited to environments according to these examples. Customer type detection and customization and/or configuration of available services may be implemented in environments employing fewer or additional systems, services, applications, engines, codes, and user experience configurations. Furthermore, the example systems, services, applications, modules, and notifications shown in FIG. 1 through 4 may be implemented in a similar manner with other values using the principles described herein.

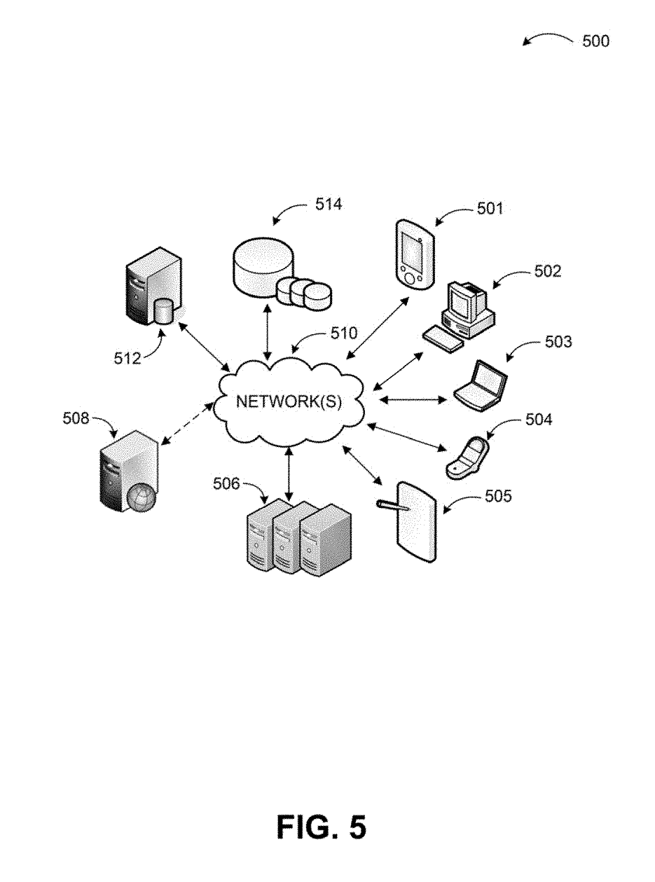

FIG. 5 is a networked environment, where a system according to embodiments may be implemented. In addition to locally installed applications (for example, application 106), customer type detection and customization and/or configuration of online services may also be employed in conjunction with hosted applications and services (for example, online service 114) that may be implemented via software executed over one or more servers 506, individual server 508, or at client devices, as illustrated in diagram 500. A hosted service or application may communicate with client applications on individual computing devices such as a handheld computer 501, a desktop computer 502, a laptop computer 503, a smart phone 504, a tablet computer (or slate), 505 (‘Client devices’) through network(s) 510 and control a user interface presented to users.

Client device's 501-505 are used to access the functionality provided by the hosted service or application. One or more of the servers 506 or server 508 may be used to provide a variety of services as discussed above. Relevant data such as customer data, and similar may be stored in one or more data stores (e.g. data, store 514), which may be managed by any one of the servers 506 or by database server 512.

Network(s) 510 may comprise any topology of servers, clients, Internet service providers, and communication media. A system according to embodiments may have a static or dynamic topology. Network.(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, engines, data sources, and data distribution systems may be employed for providing customer type detection and customization and/or configuration of online services. Furthermore, the networked environments discussed in FIG. 5 are for illustration purposes only. Embodiments are not limited to the example applications, modules, or processes.

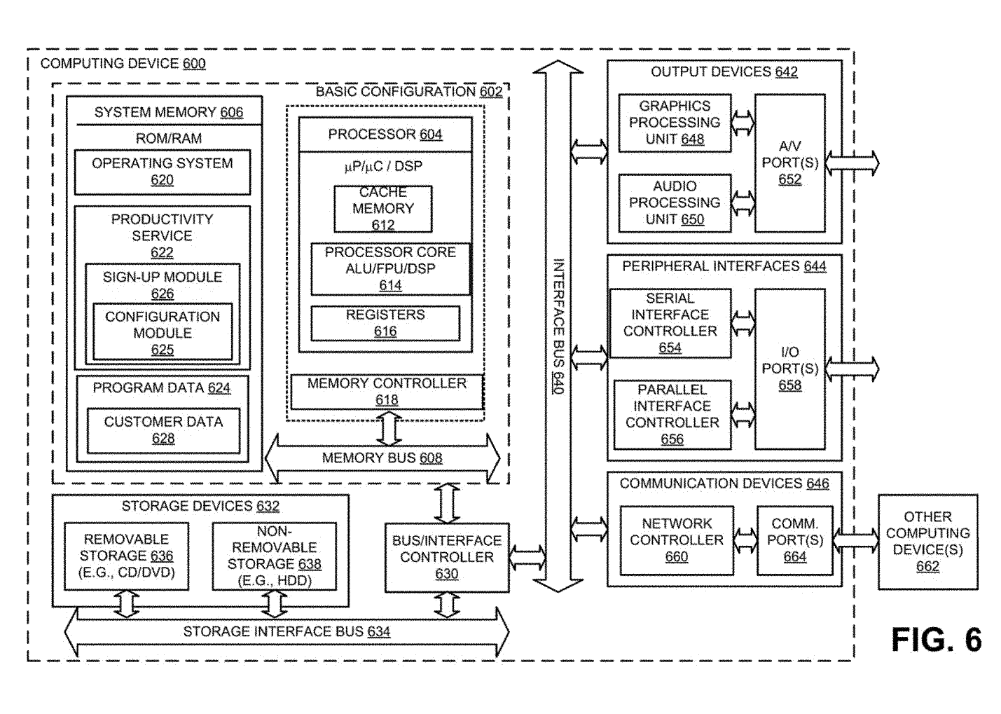

FIG. 6 is a block diagram of an example general, purpose computing device, which may be used to provide customer type detection and customization and/or configuration of online services.

For example, computing device 600 may be used us a server, desktop computer, portable computer, smart phone, special purpose computer, or similar device. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a productivity service 622, a sign-up module 626, a configuration module 625, and program data 624. The configuration module 625 may analyze one or more signals provided by a customer requesting sign-up such as an email alias, a domain name, a signature, one or more contacts, a template selection, and/or a service selection, and customize and/or configure components of the requested service or service components based on an inference made based on the analysis results. The program data 624 may include, among other data, customer data 628, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to atone a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more AN ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing; device 600 may also be implemented as a personal computer including both laptop computer and non-laptop computer configurations.

Example embodiments may also include methods to provide customer type detection and customization and/or configuration of available services. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

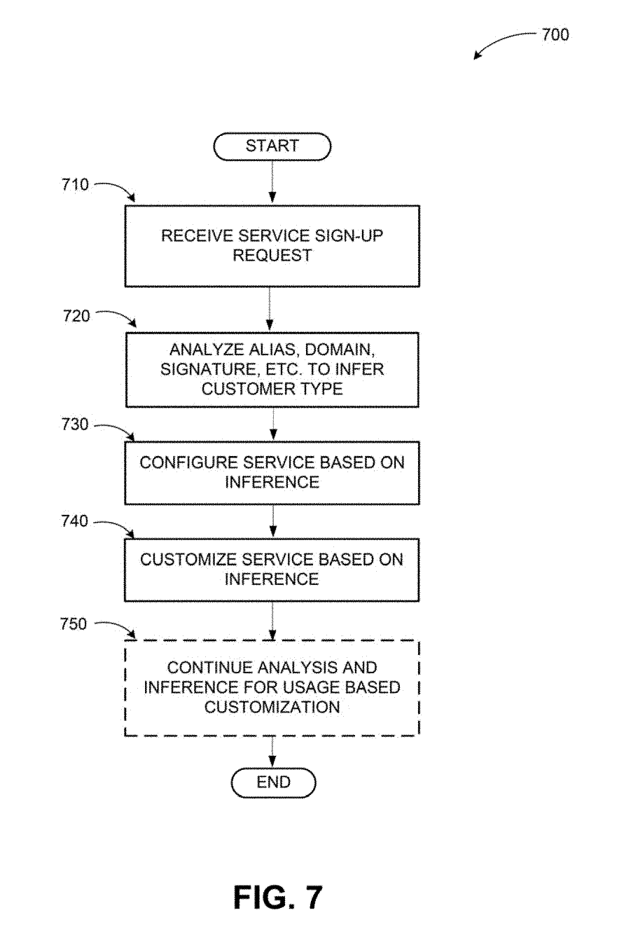

FIG. 7 illustrates a logic flow diagram of a method to provide customer type detection and customization and/or configuration of online services.

Process 700 may be implemented on a computing device, server, or other system. An example system may include a computer communicatively coupled to a cloud server hosting a productivity or a communication service.

Process 700 begins with operation 710, where a sign-up module of a hosted service may receive a sign-up request. In some scenarios, the request may include limited amount of information about the requesting customer such as an email address or a domain name. At operation 720, available information such as an email alias, a domain name, a signature, one or more contacts, a template selection, and/or a service or service component selection may be analyzed.

At operation 730, an inference may be made based on results of the analysis. The inference may be about a type of the customer, their business/organization, etc. For example, a small business or a particular type of business may be inferred from the analysis of a used or requested domain name or email alias. At operation 730, the requested service and/or its components may be configured based on the inference. For example, if the customer is inferred to be a small business retailer, the customer may be unlikely to use certain applications within the service. Thus, those applications may be deactivated in the customer's account automatically.

At operation 740, the service and/or its components may be customized based on the inference. For example, an initial teaching UI may be customized for the particular customer type. Furthermore, UIs and functionalities of the components applications may also be customized to address specific needs of the particular customer type and remove unnecessary parts. At optional operation 750, the configuration module of the service may monitor the customer's usage and continue making inferences and customizations based on the continued inference.

The operations included in process 700 are for illustration purposes. Customer type detection and customization and/or configuration of online services may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing customer type detection and customization and/or configuration of online services is provided. The means may include a means for receiving a sign-up request tor an online service; a means for analyzing one or more signals provided by a customer requesting the sign-up, the one or more signals comprising an email alias, a domain name, a signature, one or more contacts, a template, selection, and/or service component selection; a means for inferring a customer type based on the analysis; and a means for one or more of customizing and configuring the online service based on the inference.

According to some examples, a method to provide customer type detection and customization and/or configuration of online services is provided. The method may include receiving a sign-up request for an online service; analyzing one or more signals provided by a customer requesting the sign-up, the one more signals comprising an email alias, a domain name, a signature, one or more contacts, a template selection, and/or a service component selection; inferring a customer type based on the analysis; and one or more of customizing and configuring the online service based on the inference.

According to other examples, the method may also include generating a customer profile based on the inference and received customer information; and one or more of customizing and configuring the online service based on the customer profile. The method may further include perforating a keyword search based on one or more of the email alias, the domain name, and a customer name; further inferring the customer type based on one or more results of the search; receiving a configuration choice from the customer; and/or further inferring the customer type based on the configuration choice.

According to further examples, the method may also include analyzing one or more meetings and tasks scheduled by the customer; further inferring the customer type based on the analysis; and/or assigning a confidence score to the inference. The confidence score may include low, medium, and high. The confidence score may have a numeric value. One or more of customizing and configuring the online service may include selecting one or more of an initial teaching user interface, a training tutorial, an online service component to be activated, a configuration for the online service component to be activated, and a user interface configuration for the online service component to be activated.

According to other examples, a computing device to provide customer type detection and customization and/or configuration of online services is described. The computing device may include a communication interface configured to facilitate communication between the computing device and one or more servers; a memory configured to store instructions; and one or more processors coupled to the memory, where the one or more processors, in conjunction with the instructions stored in the memory, are configured to execute components of an online service. The components of the online service may include an application configured to provide processing capability associated with a specific functionality and a sign-up module. The sign-up module may be configured to receive a sign-up request for an online service; analyze one or more signals provided by a customer requesting the sign-up, the one or more signals comprising an email alias, a domain name, a signature, one or more contacts, a template selection, and/or a service component selection; infer a customer type based on the analysis; generate a customer profile based on the inference and received customer information; and select one or more of an initial teaching user interface, a training tutorial, an online service component to be activated, a configuration for the online service component to be activated, and a user interface configuration for the online service component to be activated based on the customer profile.

According to some examples, the sign-up module may be further configured to analyze each of the one or more signals provided by the customer; and assign a weight to each of the one or more signals based on the analysis. The weight may represent a likelihood of an associated signal contributing to an overall confidence score for the inference. The sign-up module may be further configured to present the overall confidence score to the customer. The overall confidence score may be computed based on a sum of individual confidence scores associated with each of the one or more signals adjusted by the weights associated with each of the one or more signals. The sign-up module may also be configured to complement the inference based on a configuration choice received from the customer or one or more of a keyword search associated with one or more of the email alias, the domain name, and a customer name.

According to further examples, a system to provide customer type detection and customization and/or configuration of online services is described. The system may include a plurality of servers configured to execute productivity applications associated with a productivity service; and a second server configured to execute a sign-up module for the productivity. The sign-up module may be configured to receive a sign-up request for the productivity service; analyze one or more signals provided by a customer requesting the sign-up, the one or more signals comprising an email alias, a domain name, a signature, one or more contacts, a template selection, and/or a productivity application selection; infer a customer type based on the analysis; generate a customer profile based on the inference and received customer information; and select one or more of an initial teaching user interface, a training tutorial, a productivity application to be activated, a configuration for the productivity application to be activated, and a user interface configuration for the productivity application to be activated based on the customer profile.

According to yet other examples, the sign-up module may be further configured to suggest to the customer the selected one or more of the initial teaching user interface, the training tutorial, the productivity application to be activated, the configuration for the productivity application to be activated, and the user interface configuration for the productivity application to be activated. The sign-up module may be further configured to automatically implement the selected one or more of the initial teaching user interface, the training tutorial, the productivity application to be activated, the configuration for the productivity application to be activated, and the user interface configuration for the productivity application to be activated. The sign-up module may also be configured to assign a numeric confidence score to the inference. The productivity application may be a word processing application, a spreadsheet application, a database application, a presentation application, a communication application, a calendar application, a collaboration application, or an online data storage application.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing, the claims and embodiments.

1. A method to provide customer type detection and customization and or configuration of online services, the method comprising;
receiving a sign-up request for an online service;
analyzing one or more signals provided by a customer requesting the sign-up, the one or more signals comprising an email alias, a domain name, a signature, one or more contacts, a template selection, and/or a service component selection;
inferring a customer type based on the analysis; and
one or more of customizing and configuring the online service based on the inference.

2. The method of claim 1, further comprising:
generating a customer profile based on the inference and received customer information; and
one or more of customizing and configuring the online service based on the customer profile.

3. The method of claim 1, further comprising:
performing a keyword search based on one or more of the email alias, the domain name, and a customer name; and
further interline the customer type based on one or more results of the search.

4. The method of claim 1, further comprising:
receiving a configuration choice from the customer; and
further inferring the customer type based on the configuration choice.

5. The method of claim 1 further comprising:
analyzing one or more meetings and tasks scheduled by the customer; and
further inferring the customer type based on the analysis.

6. The method of clam 1, further comprising:
assigning a confidence score to the inference.

7. The method of claim 6, wherein the confidence score includes low, medium, and high.

8. The method of claim 6, wherein the confidence score has a numeric value.

9. The method of claim 1 wherein one or more of customizing and configuring the online service comprises:
selecting one or more of an initial teaching user interface, a training tutorial, an online service component to be activated, a configuration for the online service component to be activated, and a user interface configuration for the online service component to be activated.

10. A computing device to provide customer type detection and customization and/or configuration of online services, the computing device comprising:
a communication interface configured to facilitate communication between the computing device and one or more servers;
a memory configured to store instructions; and
one or more processors coupled to the memory, wherein the one or more processors, in conjunction with the instructions stored in the memory, are configured to execute components of an online service, the components of the online service comprising:
an application configured to provide processing capability associated with a specific functionality; and
a sign-up module configured to:
receive a sign-up request for an online service;
analyze one or more signals provided by a customer requesting the sign-up, the one or more signals comprising an email alias, a domain name, a signature, one or more contacts, a template selection, and/or a service component selection:
infer a customer type based on the analysis;
generate a customer profile based on the inference and received customer information; and
select one or n ore of an initial teaching user interface, a training tutorial, an online service component to be activated, a configuration for the online service component to be activated, and a user interface configuration for the online service component to be activated based on the customer profile.

11. The computing device of claim 10, wherein the sign-up module is further configured to:
analyze each of the one or more signals provided by the customer; and
assign a weight to each of the one or more signals based on the analysis.

12. The computing device of claim 11, wherein the weight represents a likelihood of an associated signal contributing to a overall confidence score for the inference.

13. The computing device of claim 12, wherein the sign-up module further configured to:
present the overall confidence score to the customer.

14. The computing device of claim 12, wherein the overall confidence score is computed based on a sum of individual confidence scores associated with each of the one or more signals adjusted by the weights associated with each of the cane or more signals.

15. The computing device of claim 10 wherein the sign-up module is further configured to:
complement the inference based on a configuration choice received from the customer or one or more of a keyword search associated with one or more of the email alias, the domain name, and a customer name.

16. A system to provide customer type detection and customization and/or configuration of online services, the system comprising:
a plurality of Servers configured to execute productivity applications associated with a productivity service; and
a second server configured to execute a sign-up module for the productivity, wherein the sign-up module is configured to:
receive a sign-up request for the productivity service;
analyze one or more signals provided by a customer requesting the sign-up, the one or more signals comprising an email alias, a domain name, a signature, one or more contacts, a template selection, and/or a productivity application selection;
infer a customer type based on the analysis;
generate a customer profile based on the inference and received customer information; and
select one or more of an initial teaching user interface, a training tutorial, a productivity application to be activated, a configuration for the productivity application to be activated, and a user interface configuration for the productivity application to be activated based on the customer profile.

17. The system of claim 16, wherein the sign-up module is further configured to:
suggest to the customer the selected one or more of the initial teaching user interface, the training tutorial, the productivity application to be activated, the configuration for the productivity application to be activated, and the user interface configuration liar the productivity application to be activated.

18. The system of claim 16, wherein the sign-up module is further configured to:
automatically implement the selected one or more of the initial teaching user interface, the training tutorial, the productivity application to be activated, the configuration for the productivity application to be activated, and the user interface configuration for the productivity application to be activated.

19. The system of claim 16, wherein the sign-up module is further configured to assign a numeric confidence score to the inference.

20. The system of claim 16, wherein the productivity application is one of a word processing application, a spreadsheet application, a database application, a presentation application, a communication application, a calendar application, a collaboration application, and an online data storage application.
